(19) United States
(12) Patent Application Publication
(10) Pub. No.: US 2025/0355445 A1
(43) Pub. Date: Nov. 20, 2025

(54) AUTOMATIC RECOVERY IN ROBOTIC SYSTEMS

(71) Applicant: FLEXXBOTICS, Boston, MA (US)

(72) Inventors: Tyler Modelski, Woburn, MA (US); Tyler Bouchard, Boston, MA (US)

(21) Appl. No.: 19/211,271

(22) Filed: May 18, 2025

Related U.S. Application Data
(60) Provisional application No. 63/649,295, filed on May 17, 2024.

(51) Int. Cl. G05D 1/644

(52) U.S. Cl. CPC G05D 1/644

(57) ABSTRACT

A method of detecting and correcting an operational anomaly in an autonomous robot includes receiving an indication of an anomaly impeding performance of a robot from fulfilling a prescribed task in a workcell of the robot, and determining, based on the anomaly, a need and potential for automated recovery. A table or lookup maps, based on the anomaly, at least one remedial action corresponding to the recovery, and receives, from a central server, a command to commence the remedial action. An anomaly which is responsive to automated correction is remedied by the remedial action or set of commands, so that minor problems do not interfere with robotic production. More serious or detrimental errors or malfunctions, such as those affecting workplace safety, are likewise deferred from automatic recovery pending appropriate remedial measures.

### RELATED APPLICATIONS

This patent application claims the benefit under 35 U.S.C. § 119(e) of U.S. Provisional Patent App. No. 63/649,295, filed May 17, 2024, entitled “AUTOMATIC RECOVERY IN ROBOTIC SYSTEMS” incorporated herein by reference in entirety.

### BACKGROUND

Robotics are continually expanding into areas requiring greater precision, as control and response mechanisms become responsive to more finely tuned positioning. As robotics become more integrated in a manufacturing, development or assembly process, a greater risk is posed that substandard performance by a robot will have greater detrimental results and be more difficult to resolve. It would be beneficial to develop a monitoring or diagnostic approach that identifies and resolves anomalies in a robotic workflow.

### SUMMARY

A method of detecting and correcting an operational anomaly in an autonomous robot includes receiving an indication of an anomaly impeding performance of a robot from fulfilling a prescribed task in a workcell of the robot, and determining, based on the anomaly, a need and potential for automated recovery. A table or lookup maps, based on the anomaly, at least one remedial action corresponding to the recovery, and receives, from a central server, a command to commence the remedial action. An anomaly which is responsive to automated correction is remedied by the remedial action or set of commands, so that minor problems do not interfere with robotic production. More serious or detrimental errors or malfunctions, such as those affecting workplace safety, are likewise deferred from automatic recovery pending appropriate remedial measures.

Configurations herein are based, in part, on the observation that industrial robots, such as 6-axis collaborative utility robots, are often configured and invoked for completion of multiple tasks (jobs) via reconfiguration and different programs that allow the robot to fulfill the various tasks, such as fabrication of specific parts used in a larger apparatus or machine. A plurality of robots interconnected by a mesh network are reconfigurable by identifying configurations and commands needed by each robot for performing a task to complete a discrete quantifiable result, for example machine tending for a desired part or finished object.

Unfortunately, conventional approaches to robotic operation and machine tending suffers from the shortcoming that minor deviations or sensed variations from “typical” operation can invoke safety measures that terminate robotic actions, machine software faults, or can result in a defective finished product due to variations in cutting, tolerance and other parameters of precision parts. Accordingly, configurations herein substantially overcome the shortcomings of conventional robotic task management by providing an intelligent recovery for analyzing a severity of an anomaly, such as a deviation in operation, and determining if an automated recovery can resolve the anomaly. Operation indicating a possible human safety event commences an immediate shutdown, to prevent personal injury, but conventional approaches can trigger false positives that result in a premature robot shutdown. Such a so-called “protective stop” generally implies an immediate unconditional shutdown to prevent human injury, but other anomalies deemed not to pose a human safety risk are intended to be redressed by approaches defined herein. Similarly, deviations in tolerances or product parameters can also trigger an unnecessary shutdown in conventional processes. Accurate determination and characterization of an anomaly as recoverable can avoid such false positives triggering an immediate shutdown.

In further detail, configurations herein present a method of detecting and correcting an operational anomaly in an autonomous robot, including receiving an indication of an anomaly, where the anomaly impedes performance of a robot from fulfilling a prescribed task in a workcell of the robot. A central server or hub determines, based on the anomaly, a need and availability for a recovery, and maps a remedial action corresponding to the recovery as the robot receives a command to commence the remedial action.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a robotic environment having recovery capability as described herein;

FIG. 2 shows an industrial robot environment suitable for use with configurations herein;

FIG. 3 is a block diagram of a workflow in the workcell of FIGS. 1 and 2;

FIG. 4 is a block diagram of the robotic environment including recovery capability for the environment as in FIGS. 1-3;

FIG. 5 is a control architecture for the recovery capability of FIGS. 1 and 4;

FIG. 6 is a control flow of a robotic command sequence with recovery capability from a recipe as in FIGS. 1-5;

FIG. 7 is a control flow of the recovery sequence triggered from an anomaly detection as in FIG. 6; and

FIG. 8 is an example of commands resulting from a detected recovery and corresponding remedial action.

### DETAILED DESCRIPTION

In the discussion that follows, an example of an industrial environment includes a plurality of work cells for receiving and performing a prescribed task by the robot and associated peripherals that complement the task (job) performed by the robot. A recovery is detected and performed to mitigate unexpected downtime and instead automatically return the robot to operation.

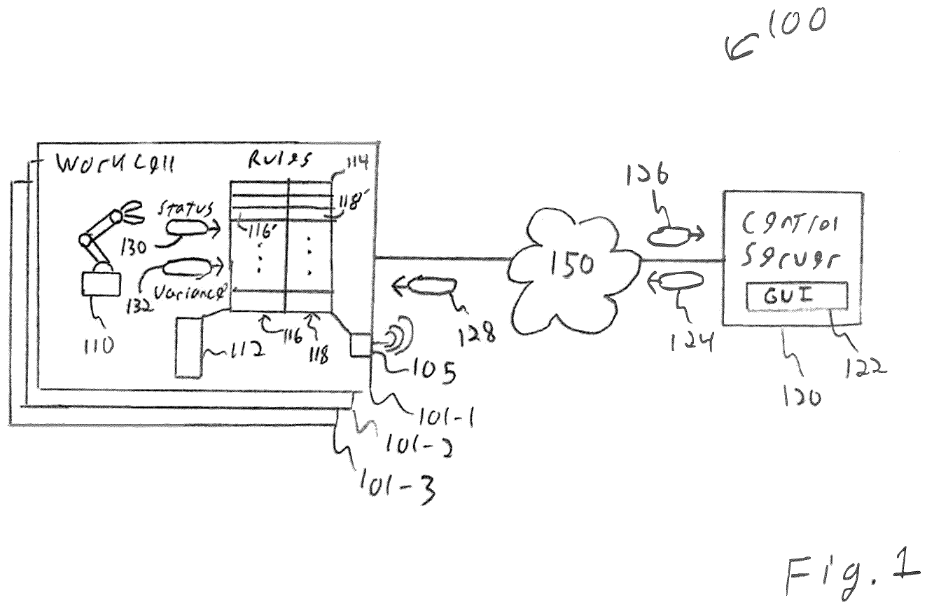

FIG. 1 is a context diagram of a robotic environment having recovery capability as described herein. In the particular configuration as depicted in FIG. 1, a plurality of workcells 101-1 . . . 101-N (101 generally) perform various reconfigurable tasks at a facility 100. Each workcell 101 includes a robot 110 and associated peripherals for performing a prescribed task. A central server 120 delegates reconfigurable tasks to the workcells 101, often via a recipe 124 of predetermined instructions for performing a prescribed task, sent responsive to a GUI (Graphical User Interface) 122.

The robots in the facility 100 are typically 6-axis industrial robots, as known in the commercial space, and commonly are collaborative robots. Other suitable robots and/or robotic entities are equally applicable to configurations herein. During normal operation, the robots 110 are each performing a respective prescribed task delegated to the workcell via a recipe 124. As with any electromechanical system, various anomalies can arise that require some level of remedial intervention. Upon occurrence of an anomaly, the received indication is typically either a status indicator 130 or a variance value 132. The workcell 101, which includes a local server 112 or processing device such as a programmable logic controller (PLC), compares the status indicator or variance value to a set of rules indicative of a need for recovery, and matches the status indicator or the variance value to at least one of the rules 116 of the set or rules 114. The server 112 then maps the matched rule 116′ to the corresponding remedial action 118′ for implementing the recovery.

In operation, the local server 112 receives an indication of an anomaly (130, 132) that impedes performance of the robot 110 from fulfilling a prescribed task in the workcell 101. The server 112 determines, based on the anomaly, a need for a recovery, and maps, based on the anomaly, at least one remedial action 118 corresponding to the recovery, and receives a command 128 to commence the remedial action.

Once commenced, the recovery sequence performs an automatic resumption from a robot variation or stop event autonomously without the need for human interaction. This occurs by detecting the robot variation or stop event, and automatically triggering a sequence of commands to be sent to resume the robotic task. In the example configuration, this may result from a status indicator 130 indicative of at least one of a non-safety protective stop, a pick/placement error, a fixture error or a machine fault, to name several.

Alternatively, if the anomaly indicates a variance 132, the variance value may be indicative of a sensor reading from a sensor in the workcell 101 having a reading falling outside of a value consistent with normal operation. A typical variance value may be indicative of a measurement falling outside a normal range, a sensed value deviating from a range, or a misplaced object, for example.

The remedial action 118 is therefore a software controllable action or set of instructions for correcting the anomaly, via an intelligent recovery without the need for human intervention or stopping the robotic workcell 101. This may involve reconfiguration of parameters, a retrying or skipping of a problematic step, invoking a utility program or instruction to clear a register, software fault, situation or physical object from the robotic path, or merely an adjustment to a parameter, as prescribed by the remedial action, as well as identifying and resuming from the point of anomaly detection. In a general sense, the indication 130, 132 of the anomaly is defined by an event received from the robot 110, determining if the event indicates a protective stop, which properly results in an immediate shutdown, and if not, determining if the event indicates a recoverable condition.

In an alternative configuration, the set of rules may involve a machine learning (ML) model, trained on successive occurrences of anomalies and resulting remedial actions. The model may receive a training set generated from successive trials and recorded anomalies, and generates a probability of likely remedial actions. The trained model may then attempt remedial actions based on the most likely prediction of recovery.

The recovery may be applied to each of a plurality of robots 110 deployed around a robotic environment 100, typically an industrial floor, factory or similar commercial enterprise. Each workcell 101 in the facility 100 generates a stream of information, forming a pipeline of events and occurrences received by the central server 120 via a network 150. Each workcell maintains an interface 105 to the central server 120 via the network 150. Typically this is a WiFi or wireless connection, however any suitable network connection will suffice. In conjunction with recovery, the workcell sends an indication 126 of the anomaly to the central server 120. The central server authorizes or commences the identified remedial action 118 with a recovery signal 128. In a particular configuration, the robots 110 may be responsive to a set of commands disseminated as a recipe, as disclosed in copending U.S. patent application Ser. No. 18/133,690, filed Apr. 12, 2023, entitled “ROBOTIC WORKFLOW RECIPE,” assigned to the assignee of the present application and incorporated herein by reference in entirety.

Often the anomaly may leave the robot 110 in an inconsistent or undetermined state. Accordingly, commencing the remedial action further includes identifying a restart point for commencing robotic activity for completing the prescribed task, and commencing the robotic activity from the identified restart point, to avoid compromise or loss of any work in progress when the anomaly was first detected.

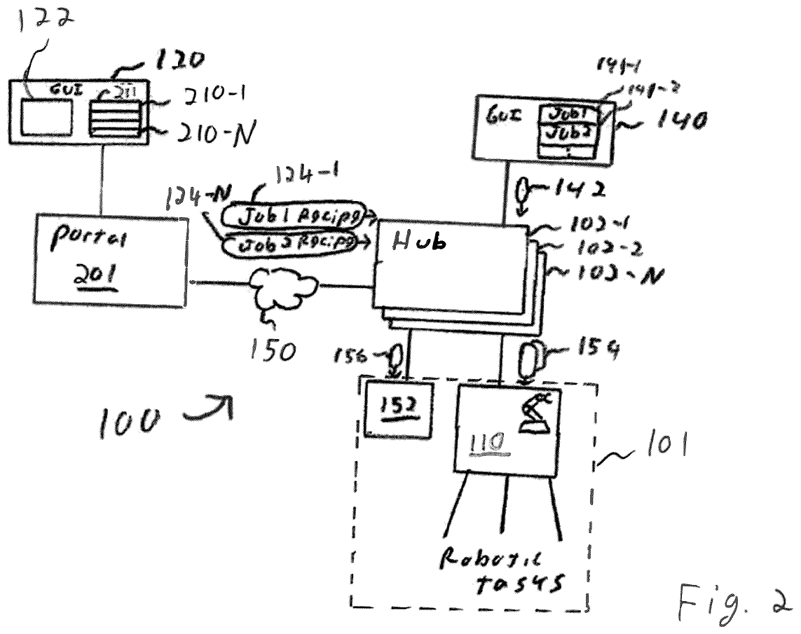

FIG. 2 shows an industrial and/or collaborative robot environment suitable for use with configurations herein. Referring to FIG. 2, the central server 120 may operate as a remote portal 201 for managing a plurality of workcells via a corresponding plurality of hubs 102-1 . . . 102-N (102 generally), each defined by computing devices. The portal 201 renders the respective GUI (Graphical User interface) 122 on a monitor or other rendering device. In an industrial environment, a method of deploying utility robots 110 includes identifying, via the GUI (Graphical User Interface) 122, a stored recipe 210 from a set or list 211 including robotic guidance elements for fulfilling a robotic task. Normal operation includes deploying the recipe to the workcell 101, such that the recipe is indicative of robotic instruction performable by the robot for achieving the prescribed task. The GUI 122 is invoked to deploy the identified recipe 210-1 . . . 210-N (210, generally) to a hub 102-1 . . . 102-N (102 generally) including a robot and an operator station. The transmitted recipe 124 includes a set of robotic guidance elements associated with the commencement and performance of the robotic task. In a general sense, robotic guidance elements include robot configuration files for initializing the utility robot for performing the robotic task, machine instructions for directing the robot in iterative actuation for performing the robotic task, and work instructions renderable to an operator display for identifying interactive elements to commence the robotic task. These also may include, but are not limited to work instructions, program files, digital media, process checks, monitoring tools, alerts and quality checks used in conjunction with the robotic task performed by the job. Other elements may also be included as needed by a particular robotic task.

Continuing with the block diagram of FIG. 1, the GUI 122 receives an operator selection for a recipe 210 for a particular robotic task from the menu 211 of available tasks. The portal 201 transmits the deployed recipe 124, including associated files, for the selected robotic task to the corresponding hub 102, and the hub 102 commences the robotic task based on the robotic guidance elements in the received recipe 124. The hub 102 performs the selected job based on the deployed recipe by invoking the robot 110 and other peripherals 152 or devices under the hub, collectively referred to as the workcell 101, called for by the deployed recipe 124.

The portal 201 and a plurality of hubs 102-N connect to a mesh network 150 coupling the portal 201 to the hubs 102. The portal renders the GUI 122 for identifying the recipe 210, and connects to one or more of the hubs 102 in communication with the robot for fulfilling the robotic task. At the hub 102, there may be a hub GUI 140 responsive to an operator selection of a plurality of jobs 141-1 . . . 141-2 (141 generally) enabled at the hub for performance by the robot 110, depending on the recipes 124 sent by the portal. The selected recipe 124 defines a prescribed task, which is a physical interaction between a utility robot and one or more objects such as peripherals 152 manipulated by or responsive to the utility robot 110 for fulfilling a quantifiable result from the physical interaction. In the example configuration, a task may be fabrication of milled parts. Collectively, each robot 110 and associated peripherals 152 define the workcell 101 suited for performing the robotic task defined by a particular job. Based on the selected job, the hub receives the robotic guidance elements corresponding to a recipe 124 and associates the recipe with the selected job 142 performable by one or more of the robots 110. This may include sending robotic guidance elements 154 to the robot, such as vendor specific machine instructions 156, to the peripherals 152 for support or testing, and some robotic guidance elements may be utilized by the hub 201, such as robotic configuration programs and operator guidance media, according to the recipe of the job at hand.

As an example robotic task, the collaborative robots or industrial robots responsive to the hub may be 6-axis robots, and may be associated with a hub 102 for performing device tending tasks such as CNC (Computer Numerical Control) machining, injection molding, welding, logistics, and other suitable tasks. In the example of a CNC robot, a recipe 124 may be defined by an individual part to be machined by a sequence of CNC instructions. In this example, each part has a corresponding recipe, which includes all the robotic guidance elements for machining the part. The corresponding job may have several revisions for variations on the part. Once the recipe is selected, the robotic guidance elements would include the set of machine instructions for directing the CNC to cut (machine) the part, such as a cutting path and depth for forming the part from a monolithic block of aluminum, for example. Also included are a configuration, including settings or initialization commands for the robot, such as cutting speeds, rotation speeds, sizing of a monolithic block to be cut, and the like. Since each workcell 101 may be interactively staffed, a set of media including written instructions (text) and/or instructional videos for guidance are also included in the recipe. Further, the machine instructions may include a mapping of cutting instruction to vendor-specific robot instructions, to allow the recipe to cover multiple robots of different vendors.

Still further, the recipe may include robotic guidance elements such as configuration files specific to a robot of a particular manufacturer. Vendor specific configuration files may be included as part of the recipe. The robot task may then be fulfilled by identifying a link to a vendor specific library, such that the vendor specific library includes robotic guidance elements specific to a robot of the respective vendor, and including a robotic guidance element from the vendor specific library in the deployed recipe. The vendor specific library provides a communications translation layer between the robot fulfilling the task and the CNC machine peripheral

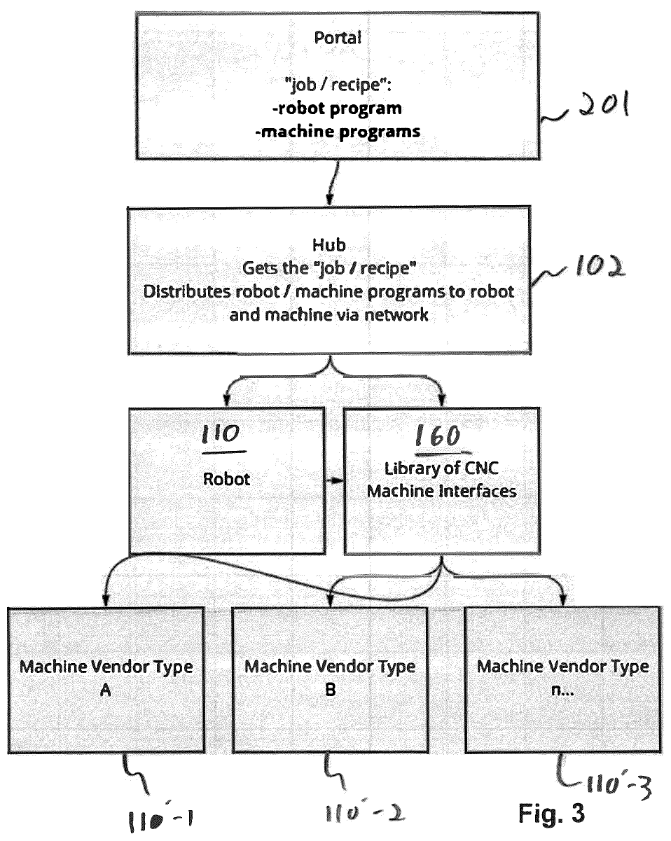

FIG. 3 is a block diagram of a workflow in the workcell of FIGS. 1 and 2. Referring to FIGS. 2-3, the portal 201 is operable to communication with a plurality of hubs 102, each defining a workcell 101 of at least one robot 110 and associated peripherals 152. The workcell 101 is in communication with a library of machine interfaces 160, each suited to a vendor specific set of commands for a particular deployed machine 110′-1 . . . 110′-3. The portal 201 transmits the recipe 124 to the robot via the corresponding hub 101-N, where the hub is in communication with the portal 201 via a respective interface, without the need to inquire of the manufacturer or type of robot. This allows the same recipe to perform a particular task (such as machining a part) across multiple workcells 101 even though the workcells 101 contain robots 110 of different vendors.

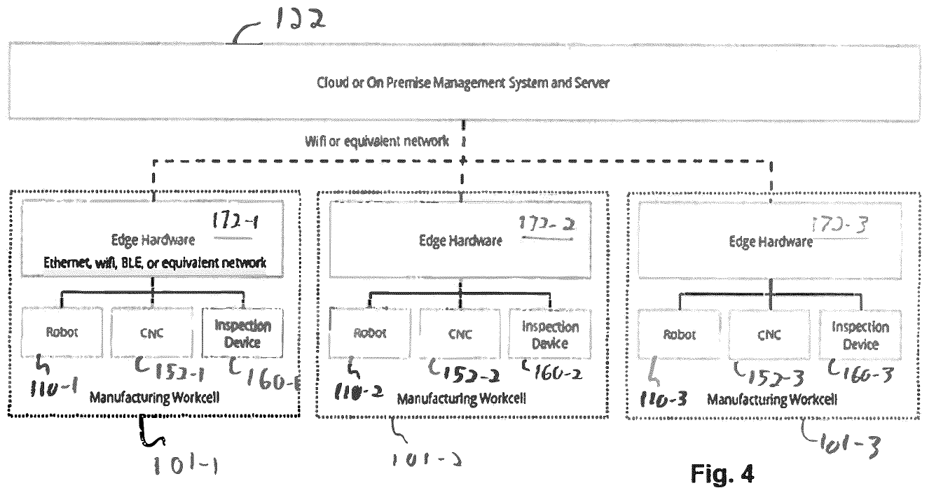

FIG. 4 is a block diagram of the robotic environment including recovery capability for the environment as in FIGS. 1-3. In particular configurations of the disclosed approach, within manufacturing environments, 6-axis robotics are oftentimes used within a workcell 101 to autonomously complete tasks. These tasks can include loading, unloading & running machines, performing welds, performing process tasks, palletizing parts or boxes, performing assembly, and others, and may include peripherals 152 for robot directed guidance or control. Inspection devices 160-1 . . . 160-3 (160 generally), represented by sensors, cameras or other suitable feedback device, gather parameters 130, 132 that indicate recovery.

The majority of 6-axis robots are pre-programmed for the tasks that they need to perform. Any variation in the process that can cause poor production, robot stops, equipment faults, and unintended robot events, are oftentimes not able to be handled. These events result in the production process stopping and human intervention needed to resume the autonomous process. These events are oftentimes caused by unforeseen, small details within 6-axis robotic arm deployment into a manufacturing environment and result in the success or failure of the robots ability to perform the autonomous manufacturing task. As indicated above, the individual robots 110 may emanate from different vendors and invoke vendor specific commands and files, even when responding to the same recipe 124 for producing the same end result. These vendor specific control elements (commands, files, drivers and the like) often include logic to stop operation when detecting deviations. These deviations may be relatively minor, and absent detection, intervention and recovery by the approach herein, would leave the robot in a halted, or process stop state indefinitely.

In order to solve process stop issues with robotics, several elements are beneficial:

1. A robust library of vendor specific communication interfaces are needed to both monitor and control all equipment that the robot is interacting with.

2. An edge computing environment is needed to monitor, configure, orchestrate, and control the robot process.

3. A centralized cloud or on premise data server is needed to historically track process variation and stop events.

4. A management system that allows for configuration of a variety of robotic recipes is needed to be able to instruct the robot on the environment it is working in, such as the central server 120/portal 201 control architecture above. By way of non-limiting example, common conditions for vendor initiated stop events concern joint current and joint torque, referring to operation of a pivoting or rotating robotic joint. When excessive force is exerted in response to movement of the robotic arm, an undue amount of torque can be detected, often along with an excessive current draw as the servo or actuator attempts to operate against the resistance. Determining the need for recovery, therefore often encompasses measuring a joint current providing power to a robotic joint, and computing if the joint current exceeds an acceptable threshold. Similarly, determining the need for recovery may include measuring a joint torque indicative of a force exerted by a robotic joint, and computing if the joint torque exceeds an acceptable threshold. Conventional approaches may construe such occurrences as a stop event based on an assumption that the robot has struck a human or other object interfering with the robotic movement.

Rather than permitting premature termination of a robotic stop or safety stop, configurations herein determine if in fact there is a safety/human involved, possibly due to a known separation of human actors from the robot range of movement. The recovery logic may also conclude that the higher current or torque value is normal for the process underway, and invoke recovery rather than simply issuing a stop command. By way of example, occurrences which may be detected and recovered include a non-safety protective stop, a pick/placement error, a fixture error or a machine fault.

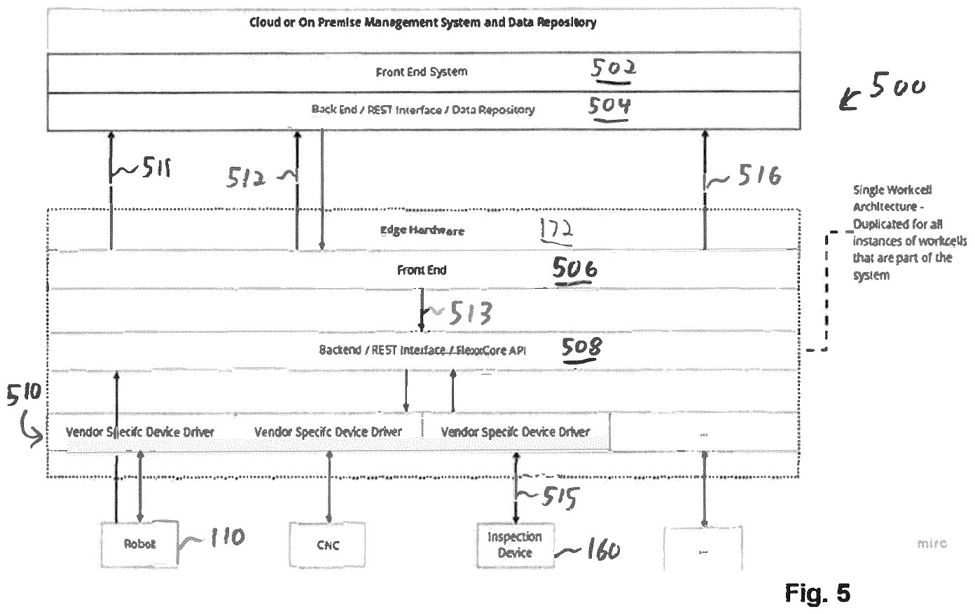

FIG. 5 depicts a control architecture for the recovery capability of FIGS. 1 and 4. Referring to FIG. 5, a system control architecture within a manufacturing environment governs the environments of FIGS. 1-3. The disclosed approach depicts CNC (Computer Numerical Control), however any suitable prescribed task and corresponding recipe may be invoked. A cloud or on premise server, such as the central server 120 and/or portal 201, hosts management system, services, and data repositories. A series of manufacturing workcells 101 is comprised of robots 110 machines or peripherals 152-1 . . . 152-3 (152 generally) responsive to the robot for implementing the task, and inspection devices 170-1 . . . 170-3 (170 generally) or equivalent, such as sensors, cameras and control software for evaluating results and conditions underlying a potential stop event. Edge hardware 172-1 . . . 172-3 (172 generally) for the workcell 101 is used to connect and communicate to robots, machines, inspection devices, or equivalent, including communications with the central server 120.

FIG. 5 describes the software architecture 500 that runs on top of the robots 110 and server 120, from a common control provided by the server 120 to the vendor specific aspects for respective robots. The software architecture is designed for distribution of job recipes for the re-configuration of robots (referenced in the copending application cited above), as well as monitoring of robotic workcell events, and control and communication of various robot and peripherals such as machines and devices.

Robotic control, monitoring and recovery as depicted in FIG. 5 may employ a REST API (Representational State Transfer Application Programming Interface), which provides a standardized way to interact with the robot's hardware and software through HTTP requests for wired or wireless networked control. The layered appearance depicts the control flow of FIGS. 1-4, including a front end 502, used to configure recipes 124 of configurations that are deployed to the robots 110. This gathers and visualizes real time and historical event data being monitored on the robot for utilization tasks, production yield, variability, and stop events, residing on the central server 120. A backend 504/REST API/Data Repository is used to communicate with the data repository for stored recipes 124 and related configurations.

For each workcell 101, a front end workcell interface 506 is used to deploy robot recipe configurations, visualize data, control robot and peripherals, and commands to commence the prescribed tasks. A backend API 508 interfaces with services and a robot API layer to control interfaces that communicate data to and from various vendor specific equipment and/or peripherals 152. Finally, the peripherals 152 and robots 101 invoke vendor specific device drivers 510 to vendor specific equipment that are compatible with the entirety of the software stack. These are utilized for both recipe distribution as well as control of the peripheral equipment from the workcell 101 and/or robot 110.

In operation, edge hardware is registered 511 with the management system to allow for recipe configuration and data repositories to be contextualized to the workcell. Users/operators request recipe configuration data for the particular robot task at 512. At 513, the requested data is distributed through the API to the robot and various pieces of equipment and peripherals in the workcell 101. The backend/API 508 is responsible for instantiating 514 the correct drivers to be used for the robot utilization task and both sending configuration data to the robots and peripherals as well as monitoring events from the robots and peripherals. Vendor specific drivers communicate 515 to and from the vendor specific equipment for the monitored data of deviations/variances and stop events for recovery evaluation. At 516, event data is tracked and stored in the management system and data repository through the edge hardware/workcell software.

In an example of deviation detection and recovery, the inspection device 160 may gather and report a variance value, indicative of at least one of a measurement falling outside a normal range, a sensed value deviating from a range, or a misplaced object. In general, such a variance value is indicative of a sensor reading from a sensor in the workcell, the sensor reading falling outside of a value consistent with normal operation in performing the prescribed task.

Once a prescribed task is commenced, a series of data items are gathered and monitored. monitored. These may include
Status Events
Label Events
Variable Events
Part Count Events
Failure Events
Cycle Events
   Each robot vendor provides an interface and/or API for gathering relevant data by monitoring events through each vendor specific library. If a change in any of the states of a particular machine or equipment occurs, an event is sent to the centralized data repository and associated with the workcell, robot task, and recipe. Conventional approaches have little tolerance to negative or performance events, and tend to simply issue a shutdown/stop rather than evaluate and perform a recovery.

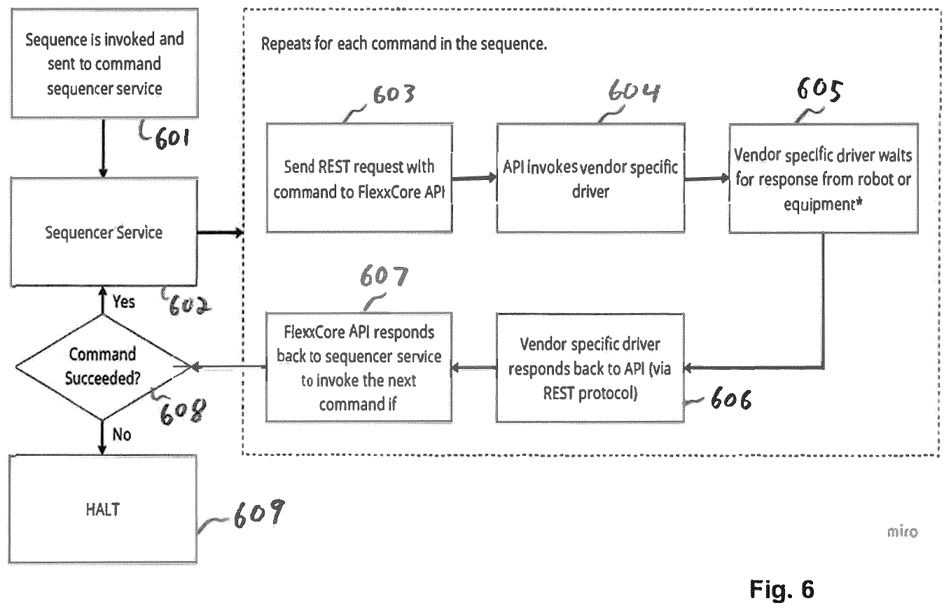

FIG. 6 is a control flow of a robotic command sequence with recovery capability from a recipe as in FIGS. 1-5. Referring to FIGS. 1-6, a normal production run or session for a robot is typically commenced with a recipe 124 from the central server 120. The recipe 124 includes commands directing a robotic action or movement. The hub 101 or portal 201 engages with an application programming interface (API) of the robot 110, such that the API is configured for transmitting commands to the robot and for receiving an indication of an anomaly occurrence, as depicted at step 601. A sequencer service 602 issues each respective command based on the recipe 124. Upon receipt by the robot 603, the robot 110 identifies and invokes a driver based on the robot vendor, as depicted at 604. Responsively, the driver waits for a response to the command, as shown at step 605. A response is received by the driver at 606, and a response back to the sequence 602, as shown at step 607. A check is performed at step 608, to determine if the command completed successfully, and if so, the sequencer 602 invoked for the next command.

Alternatively, if the check at 608 determines that the robot has ceased to perform the prescribed task based on an anomaly, the robot 110 concludes, based on the determination of the need for recovery, that a stoppage should be considered at step 609.

The communication between the sequencer 602, including evaluating the result at each command at step 608, allows intelligent evaluation of the result, instead of a blanket stop, if there is a deviation indicated by the result. This involves a vendor specific API for receiving and evaluating the return status to determine if an automated recovery is viable, or if the robot 110 needs to terminate. Conventional approaches provide no such evaluation and recovery, and rather merely terminate in the event of an adverse command.

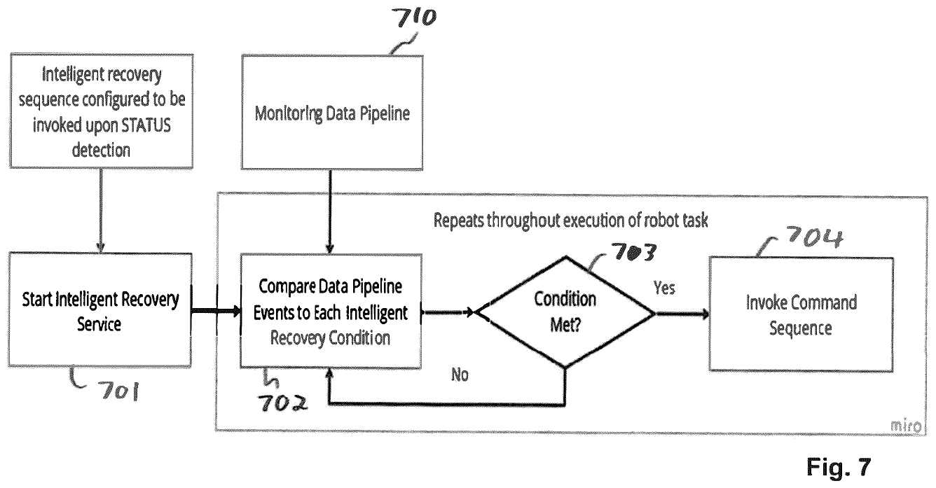

FIG. 7 is a control flow of the recovery sequence triggered from an anomaly detection as in FIG. 6. From the check at step 608, if a successful completion did not occur, the intelligent recovery is commenced at step 701 for the remedial action correcting the anomaly. The recovery sequence further identifies the point of failure/anomaly, and resumes from the last successful command or operation. As indicated above, the robotic operations are guided by a recipe including configuration and robotic task information completed in the workcell. The anomaly detection logic and recovery is included and/or reference from the recipe. Therefore, recovery includes identifying the last successful step or point of progress in the recipe, and resuming from the point of failure based on the recipe.

Intelligent recovery as disclosed herein refers to the ability to recover from a robot variation or stop event autonomously without the need for human interaction. This occurs by detecting a robot variation or stop event to automatically trigger a sequence of commands to be sent through the Edge Backend/API and vendor specific libraries to resume the robotic task.

Recovery leverages the sequencers shown in FIG. 6, however, the method in which they are triggered is specific. The triggering methodology 701 leverages a data pipeline 710 accumulated based on the robot 110 experiencing the anomaly.

In summary the data pipeline comprises the following information:
Status
Labels
Part Counts
Failure Counts
Variable Data
   At step 702, the recovery compares the data pipeline 710 to the conditions for intelligent recovery as called for by the set of rules 114 as in FIG. 1. At step 703, a check is performed to determine if a condition is met for a particular rule 116′, and if so, the remedial action 118′ corresponding to the matched rule 116′ is invoked via a corresponding command sequence, otherwise control reverts to step 702 to evaluate additional rules.

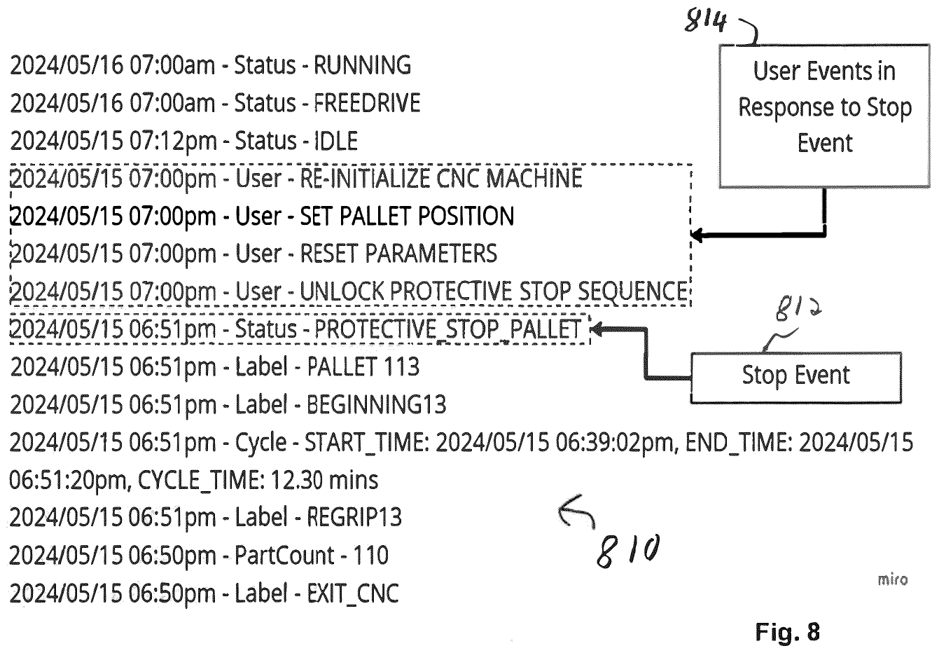

FIG. 8 is an example of commands resulting from a detected recovery and corresponding remedial action. It is generally preferable to restart the prescribed task following completion of the remedial action. The monitored data pipeline 710 provides a centralized database of stop events, user events, and sequences/commands associated with user events. An example of event detection around stop events and user events allows identification as to the state of completion at the time of the anomaly occurrence, designated as a stop event 812. Commencing the remedial action further includes identifying a restart point for commencing robotic activity for completing the prescribed task, and commencing the robotic activity from the identified restart point. Relevant events 814 in response to the recoverable stop 812 allow identification of the restart point for complete recovery.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method of detecting and correcting an operational anomaly in an autonomous robot, comprising:
receiving an indication of an anomaly, the anomaly impeding performance of a robot from fulfilling a prescribed task in a workcell of the robot;
determining, based on the anomaly, a need for a recovery;
mapping, based on the anomaly, at least one remedial action corresponding to the recovery; and
receiving a command to commence the remedial action.

2. The method of claim 1 wherein the indication of the anomaly is defined by an event received from the robot, further comprising:
determining if the event indicates a human safety event; and
if not, determining if the event indicates a recoverable condition.

3. The method of claim 2 wherein determining the need for recovery further comprises:
measuring a joint current providing power to a robotic joint, and
computing if the joint current exceeds an acceptable threshold.

4. The method of claim 2 wherein determining the need for recovery further comprises:
measuring a joint torque indicative of a force exerted by a robotic joint; and
computing if the joint torque exceeds an acceptable threshold.

5. The method of claim 1 wherein receiving the indication further comprises:
receiving at least one of a status indicator or a variance value;
comparing the status indicator or variance value to a set of rules indicative of a need for recovery; and
matching the status indicator or the variance value to at least one of the rules of the set or rules; and
mapping the matched rule to a remedial action for implementing the recovery.

6. The method of claim 5 wherein the status indicator is indicative of at least one of:
a non-safety protective stop,
a pick/placement error,
a fixture error or
a machine fault.

7. The method of claim 5 wherein the variance value is indicative of a sensor reading from a sensor in the workcell, the sensor reading falling outside of a value consistent with normal operation in performing the prescribed task.

8. The method of claim 5 wherein the variance value is indicative of at least one of:
a measurement falling outside a normal range;
a sensed value deviating from a range;
a misplaced object.

9. The method of claim 1 further comprising:
engaging with an application programming interface (API) of the robot, the API configured for transmitting commands to the robot and for receiving the indication of the anomaly;
determining that the robot has ceased to perform the prescribed task based on the anomaly;
concluding, based on the determination of the need for recovery, that a stoppage is inappropriate; and
commencing the at least one remedial action, the remedial action correcting the anomaly; and
restarting the prescribed task following completion of the remedial action.

10. The method of claim 1 wherein commencing the remedial action further comprises:
identifying a restart point for commencing robotic activity for completing the prescribed task, and commencing the robotic activity from the identified restart point.

11. The method of claim 1, further comprising deploying a recipe to the workcell, the recipe indicative of robotic instruction performable by the robot for achieving the prescribed task.

12. A system for detecting and correcting an operational anomaly in an autonomous robot, comprising:
a robot disposed in a workcell and responsive to a recipe from a central server, the recipe including predetermined instructions for a prescribed task;
an interface to the robot for receiving an indication of an anomaly, the anomaly impeding performance of a robot from fulfilling a prescribed task in a workcell of the robot;
at least one sensor configured to communicate, to the robot, an indication of an anomaly;
a set of rules for determining, based on the anomaly, a need for a recovery;
mapping, based on the anomaly, at least one remedial action corresponding to the recovery; and
a recovery sequence, the recovery sequence responsive to a command to commence the remedial action, the remedial action for reestablishing the prescribed task based on a point of failure determined by the anomaly.

13. A computer program embodying program code on a non-transitory computer readable storage medium that, when executed by a processor, performs steps for implementing a method of detecting and correcting an operational anomaly in an autonomous robot, the method comprising:
receiving an indication of an anomaly, the anomaly impeding performance of a robot from fulfilling a prescribed task in a workcell of the robot;
determining, based on the anomaly, a need for a recovery;
mapping, based on the anomaly, at least one remedial action corresponding to the recovery; and
receiving a command to commence and perform the remedial action.
